(19) United States
(12) Patent Application Publication
(10) Pub. No.: US 2003/0011629 A1
(43) Pub. Date: Jan. 16, 2003

(54) System to provide instructional information

(76) Inventors: Jennifer K. Rouse, Waukesha, WI (US); Chad D. Meyers, Milwaukee, WI (US)

Correspondence Address: BUCKLEY, MASCHOFF, TALWALKAR, & ALLISON, 5 ELM STREET, NEW CANAAN, CT, 06840, US

(21) Appl. No.: 09/752,381

(22) Filed: Dec. 28, 2000

(51) Int. Cl. G06F 3/14

(52) U.S. Cl. 345/705; 345/714

(57) ABSTRACT

A system to provide instructional information includes presentation of instructional text describing a plurality of steps to perform a task and a plurality of alternative media indicators each associated with one or more of the plurality of steps. Moreover, after reception of a selection of one of the plurality of alternative media indicators, an alternative media presentation instructing performance of the one or more of the plurality of steps associated with the selected alternative media indicator is presented.

### BACKGROUND OF THE INVENTION

1. Field of the Invention

The present invention relates to systems for providing instructional information. More specifically, the present invention relates to systems which provide searchable multimedia instructional information.

2. Discussion of the Prior Art

Due to advances in computing power and storage capacities, computing systems have become a popular means for providing instructional information to users. Advantageously, such a computing system allows a user to receive instructional information at the user's convenience and at any location that is in communication with the computing system. Moreover, the instructional information may include audio, video and text, thereby providing a satisfactory substitute for classroom or laboratory instruction.

In one example, a user of a conventional computing system searches a database of instructional information using certain keywords, receives a search results page displaying results of the search, selects one of the search results, and receives a new page presenting information corresponding to the selected search result. The presented information typically consists of instructional text and an icon corresponding to an audio/video presentation. The user may read the text and select the icon in order to view the audio/video presentation. However, if the presented information is not the information which the user desires, the user must return to the search results page and select another one of the search results.

One drawback of the above-described conventional system is that the user is required to sit through the entire audio/video presentation even if the user is interested only in a last portion of the presentation. Additionally, it is quite time-consuming for the user to return to the search results page and select search result after search result until a desired page of instructional information is received. These problems are exacerbated in low-bandwidth implementations, such as a dial-up network, in which low data transfer rates increase the delays inherent to the conventional systems.

### BRIEF SUMMARY OF THE INVENTION

In order to address the above problems, the present invention concerns a system to provide instructional information which comprises presentation of instructional text describing a plurality of steps to perform a task and a plurality of alternative media indicators each associated with one or more of the plurality of steps. Moreover, after reception of a selection of one of the plurality of alternative media indicators, an alternative media presentation instructing performance of the one or more of the plurality of steps associated with the selected alternative media indicator is presented. By virtue of the foregoing features, a user is able to select and receive both a text explanation of steps to perform a task and an alternative media presentation associated with a subset of the steps. Accordingly, time can be saved by allowing a user to choose not to receive a presentation dealing with steps with which the user is not concerned.

In another aspect, the present invention relates to a system to provide instructional information comprising presentation of a search interface for inputting search terms, for presenting a plurality of search results, and for allowing selection of one of the plurality of search results, and an instructional interface for presenting instructional text and an alternative media indicator associated with an alternative media presentation. The system further comprises reception of a selection of the one of the plurality of search results, and presentation, after the selection is received, of the plurality of search results and the instructional interface simultaneously, the simultaneously presented instructional interface comprising instructional text and an alternative media indicator corresponding to the selected one of the plurality of search results. The foregoing features increase convenience to a user by allowing the user to select a search result in a search interface while being presented with instructional information corresponding to another search result. Accordingly, relevant search results are identified more easily than in conventional systems.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is an outward view of a user interface providing instructional information according to embodiments of the invention.

FIG. 2 is a diagram of a system architecture according to embodiments of the invention.

FIG. 3 is a block diagram illustrating an internal architecture of a server according to embodiments of the present invention.

FIG. 4 is a block diagram of a software architecture according to embodiments of the invention.

FIGS. 5A and 5B illustrate a tabular representation of a portion of a showme database according to embodiments of the present invention.

FIG. 6 is a block diagram illustrating an internal architecture of a user device according to embodiments of the present invention.

FIG. 7 is a flow diagram of process steps to provide instructional information according to embodiments of the invention

FIG. 8 is an outward view of a user interface providing instructional information according to embodiments of the invention

FIG. 9 is an outward view of a user interface providing instructional information according to embodiments of the invention.

FIG. 10 is an outward view of a user interface providing instructional information according to embodiments of the invention.

FIG. 11 is an outward view of a user interface providing instructional information according to embodiments of the invention.

FIG. 12 is an outward view of a user interface providing instructional information according to embodiments of the invention.

FIG. 13 is an outward view of a user interface providing instructional information according to embodiments of the invention.

### DETAILED DESCRIPTION OF THE INVENTION

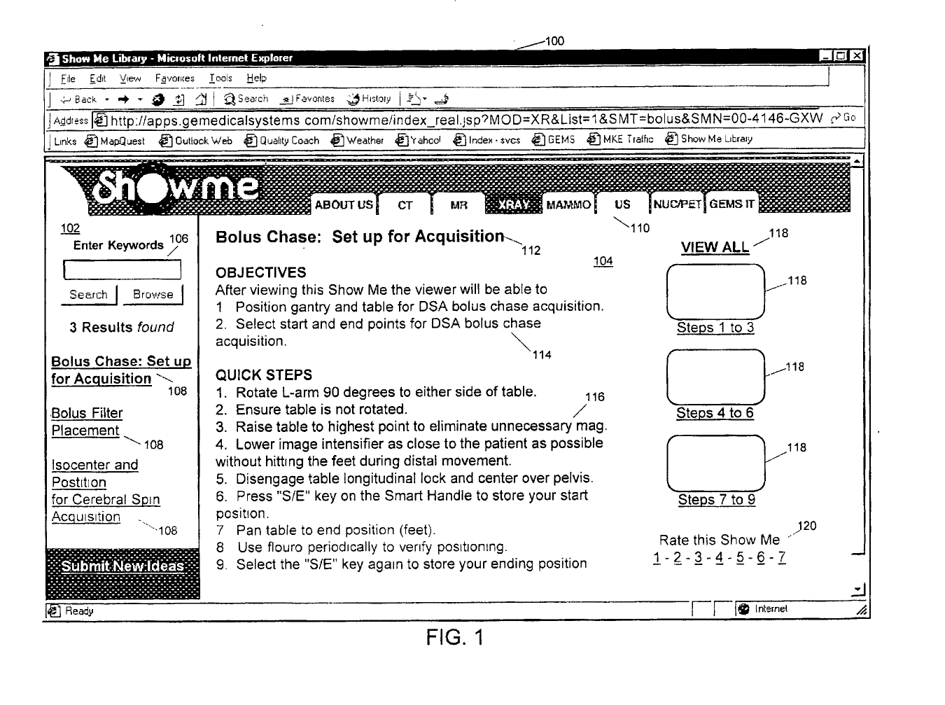

FIG. 1 is an outward view of user interface 100 according to some embodiments of the present invention. Generally, user interface 100 is used to present instructional information to a user. Although a system for providing user interface 100 will be described in detail below, a general description of user interface 100 is provided initially in the interest of providing an immediate introduction to features of the present invention.

As shown, user interface 100 is presented as a World Wide Web (“Web”) page within a window of an executing Web browser application. User interface 100 includes search interface 102 and instructional interface 104. In one embodiment, search interface 102 is used to input search terms into search term input box 106 and to present, based on the input search terms, a plurality of search results such as search results 108.

Instructional interface 104 includes modality tabs 110 specifying particular areas of instruction. Instructional interface 104 also presents an instruction topic 112, instructional text 114, instructional text 116 and alternative media indicators 118. For purposes of the present disclosure, a group of instructional topic 112, instructional text 114, instructional text 116, alternative media indicators 118 and associated alternative media presentations which may be presented to a user through instructional interface 104 will be referred to as a “showme”. Of course, instructional interface 104 may display various combinations of all or some of this group of elements in accordance with embodiments of the invention.

Returning to the specific features of instructional interface 104, instruction topic 112 describes a general task to be taught to the user. Similarly, instructional text 114 comprises objectives sought through presentation of information by instructional interface 104. Such objectives may include any objectives sought through instruction, such as to teach a user how to perform the task described by instruction topic 112, to teach a user how to perform several tasks generally described by instruction topic 112, to add to a user's knowledge, to add to a user's skillset, and to increase a user's proficiency at given tasks.

Instructional text 116 comprises a plurality of steps for performing the task described by instruction topic 112, and alternative media indicators 118 represent alternative media presentations related to the task. Alternative media indicators 118 may take many forms, including text, icons, still and moving video images, other indicators, and any combination thereof. Each alternative media indicator 118 is associated with a plurality of the steps of instructional text 116. In operation, selection of an alternative media indicator 118 causes presentation of an alternative media presentation instructing performance of the plurality of steps associated with the selected alternative media indicator 118. The alternative media presentation may be in audio, video, audio/video, or another perceptible form. In the present example, each of three of the alternative media indicators 118 is associated with three different steps of instructional text 116, and “View All” indicator 118 is associated with all the steps of instructional text 116. Accordingly, selection of “View All” indicator 118 causes presentation of an alternative media presentation instructing performance of all the steps of instructional text 116.

In other embodiments, alternative media indicators 118 are associated with different combinations of the steps of instructional text 116. That is, one alternative media indicator 118 may be associated with steps 1 to 4 and a second alternative media indicator may be associated with steps 3 to 6. According to another example, one alternative media indicator 118 may be associated with steps 1 to 4 and 7 while another alternative media indicator 118 is associated with steps 4 to 8. Due to the foregoing, a user may choose to be presented with one of several alternative media presentations associated with a subset of steps to perform a task. As a result, the user can avoid receiving a presentation associated with steps in which the user is not interested.

As can be seen from FIG. 1, instruction topic 112 corresponds to search result 108 that has been selected in search interface 102, with the selection being indicated by bold type. Accordingly, a selection of one of search results 108 causes presentation of corresponding instruction topic 112, instructional text 114, instructional text 116, and alternative media indicators 118 by instructional interface 104. In some embodiments, selection of another one of search results 108 results in presentation of instruction topic 112, instructional text 114, instructional text 116, and alternative media indicators 118 corresponding to the selected search result 118 by instructional interface 104. It should be noted that search interface 102 and instructional interface 104 are displayed simultaneously throughout the foregoing selection process. Advantageously, such an arrangement allows a user to quickly identify relevant search results 108.

Also shown in FIG. 1 is rating interface 120. Rating interface 120 allows a user to rate a showme presented by user interface 100. The rating may then be used to revise or delete the rated showme or another showme.

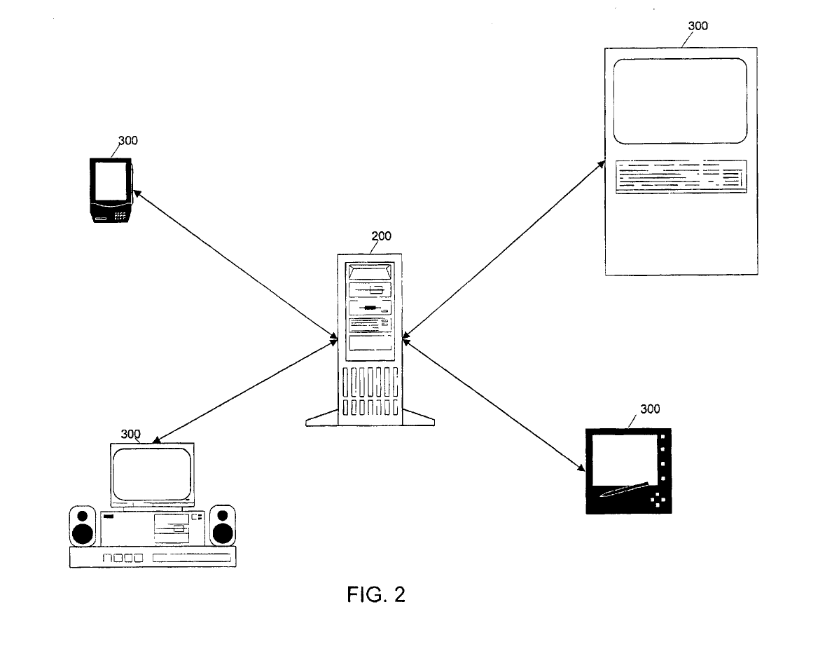

FIG. 2 is a topographic view of a network architecture according to embodiments of the present invention. The architecture of FIG. 2 comprises server 200 in communication with user devices 300. It should be understood that many other architectures, including a single stand-alone device, may be used to implement the invention.

Server 200 is depicted in FIG. 2 as a network server. Server 200 may be used to present information such as user interface 100 to a user in the manner described in detail below. Server 200 may be operated by an educational institution, an equipment manufacturer, or any other entity desiring to provide instructional information to users. Many other types of computing hardware may be used to perform the functions of server 200, including, but not limited to, a mainframe, a workstation, a network of devices, or any combination of one or more of the foregoing.

According to some embodiments, server 200 receives search terms from a client device 300, transmits a Web page including search results to the client device 300, receives a selection of a search result from the client device 300, and transmits a Web page comprising a search interface presenting the search terms and an instructional interface presenting instructional text and an alternative media indicator corresponding to the selected search result. Server 200 also may receive a selection of an alternative media indicator from the client device 300 and transmit an associated alternative media presentation to the client device 300.

As shown in FIG. 2, client devices 300 may comprise a personal digital assistant, a kiosk, a pen-based computer, and a workstation. Client devices 300, according to some embodiments, receive data comprising a user interface from server 200, present the user interface to a user, receive search terms from the user, transmit the search terms to server 200, receive search results from server 200, present the search results to the user, receive a selection of a search result from the user, transmit the selection to server 200, and receive a user interface from server 200, the user interface comprising a search interface presenting the search terms and an instructional interface presenting instructional text and an alternative media indicator corresponding to the selected search result. Client devices 300 may also receive a selection of an alternative media indicator from a user, transmit the selection to server 200, receive an associated alternative media presentation from server 200, and present the alternative media presentation to the user.

Client devices 300 according to the present invention may be any devices suitable for receiving and transmitting data and for presenting data to a user, visually and/or aurally. Such devices include, but are not limited to, a computer terminal, a cellular telephone, an in-car computer, and a device about which instructional information is being sought, such as a medical device. Of course, client devices 300 should be able to communicate with server 200 over whatever type of network media exist between the devices.

In this regard, although the connections illustrated between the devices of FIG. 2 appear dedicated, it should be noted that each of the connections may be shared by other devices. Moreover, the connections may comprise one or more of a local area network, a wide area network, a telephone network, a cellular network, a fiber-optic network, a satellite network, an infrared network, a radio frequency network, or any other type of network which may be used to transmit information between devices. Additionally, the devices shown as in communication with other devices need not be constantly exchanging data, rather, the communication may be established when necessary and severed at other times or always available but rarely used to transmit data.

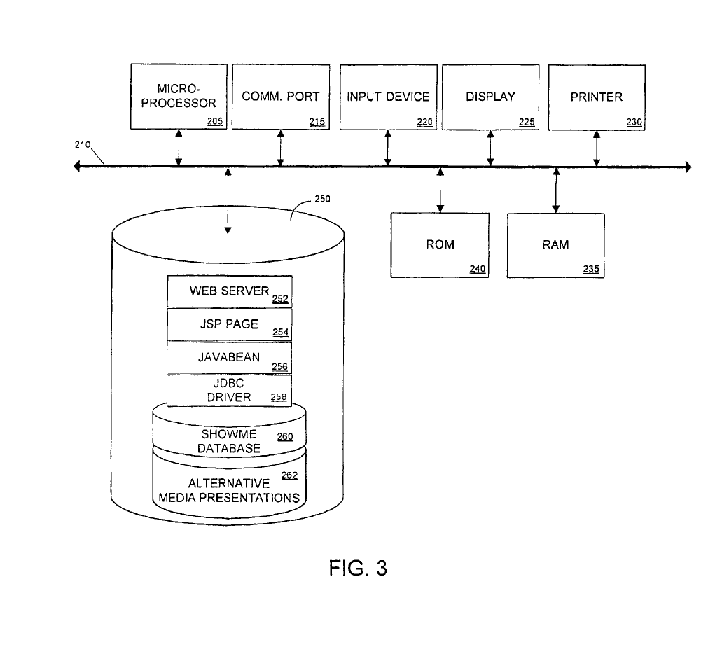

FIG. 3 is a block diagram of the internal architecture of server 200 according to embodiments of the invention. As illustrated, server 200 includes microprocessor 205 in communication with communication bus 210. Microprocessor 205 may be a Pentium, RISC-based, or other type of processor and is used to execute processor-executable process steps so as to control the elements of server 200 to provide desired functionality.

Also in communication with communication bus 210 is communication port 215. Communication port 215 is used to transmit data to and to receive data from external devices Communication port 215 is therefore preferably configured with hardware suitable to physically interface with desired external devices and/or network connections. In one embodiment, requests for Web pages and user interfaces providing instructional information according to the invention are received from and transmitted to client devices 300 over communication port 215.

Input device 220, display 225 and printer 230 are also in communication with communication bus 220. Any known input device may be used as input device 220, including a keyboard, mouse, touch pad, voice-recognition system, or any combination of these devices. Input device 220 may be used by a user to input search terms, to select search results, and to select an alternative media indicator.

Display 225, which may be an integral or separate CRT display, flat-panel display or the like, is used to output graphics and text to a user in response to commands issued by microprocessor 205. Such graphics and text may comprise a user interface as described herein. Printer 230 is an output device that produces a hardcopy of data using ink-jet, thermal, dot-matrix, laser, or other printing technologies. Printer 230 may be used to produce a hardcopy of instructional text corresponding to a search result according to embodiments of the invention.

RAM 235 is connected to communication bus 210 to provide microprocessor 205 with fast data storage and retrieval. In this regard, processor-executable process steps being executed by microprocessor 205 are typically stored temporarily in RAM 235 and executed therefrom by microprocessor 205 ROM 240, in contrast, provides storage from which data can be retrieved but to which data cannot be stored Accordingly, ROM 240 is used to store invariant process steps and other data, such as basic input/output instructions and data used during system boot-up or to control communication port 215.

Data storage device 250 stores processor-executable process steps comprising web server 252. Microprocessor 205 executes processor-executable process steps of Web server 252 in order to receive and to transmit data using the Hypertext Transfer Protocol, thereby enabling server 200 to communicate with client devices 300 over the Web.

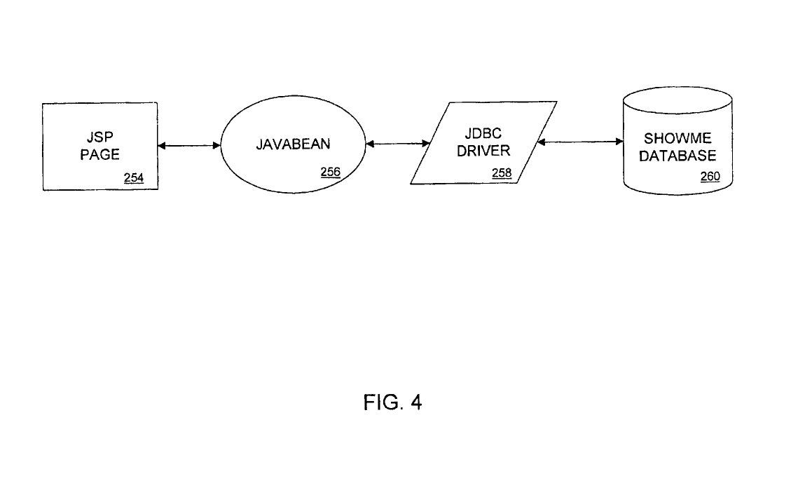

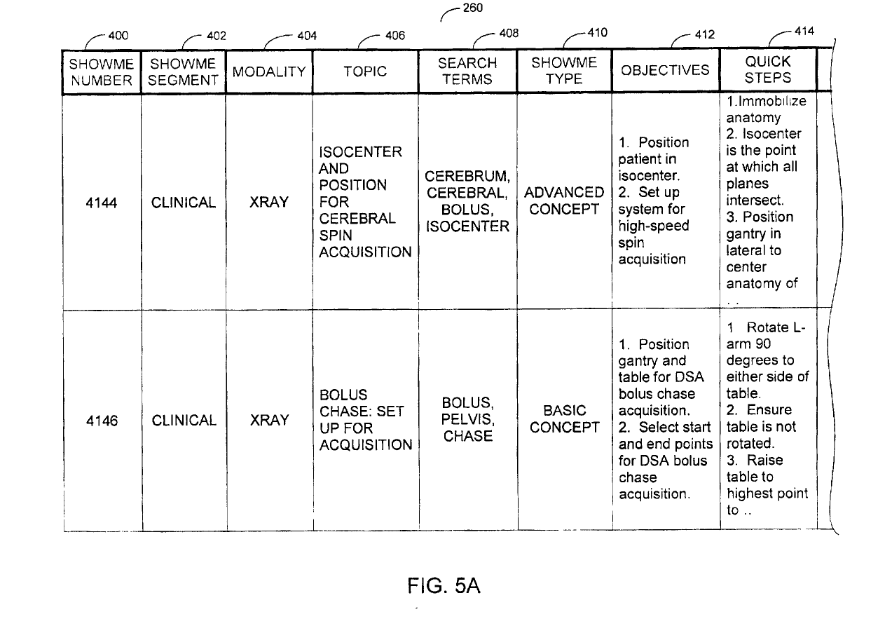

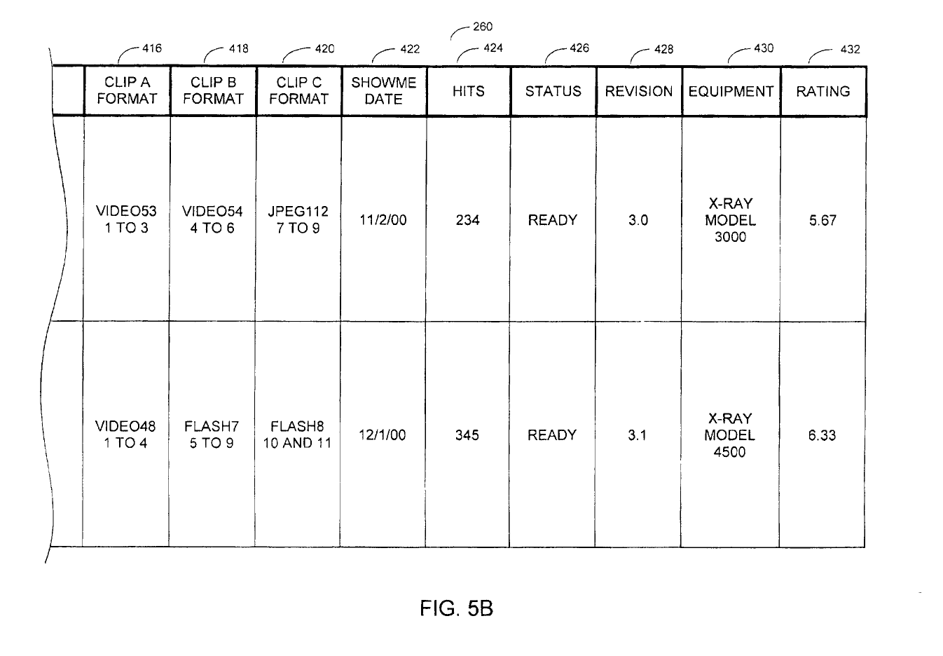

Also stored in data storage device 250 are processor-executable process steps of JSP page 254, Javabean 256 and JDBC driver 258. These process steps may be read from a computer-readable medium, such as a floppy disk, a CD-ROM, a DVD-ROM, a Zip disk, a magnetic tape, or a signal encoding the process steps, and then stored in data storage device 250. JSP page 254, Javabean 256 and JDBC driver 258 are used to create Web pages for transmission to client devices 300. Generally, elements 254 to 258 receive requests from Web server 252 and use information stored in showme database 260 of data storage device 250 to create appropriate Web pages in response to the requests. Showme database 260 will be discussed in detail with respect to FIGS. 5A and 5B, and creation of Web pages will be discussed in greater detail with respect to FIG. 4.

Data storage device 250 also stores database 262 of alternative media presentations. According to the illustrated embodiment, a user selects an alternative media indicator of an instructional interface presented by client device 300, the selection is transmitted to Web server 252, an alternative media presentation corresponding to the selected indicator is retrieved from alternative media presentation database 262, the presentation is transmitted to client device 300, and the presentation is presented to the user.

The data stored in data storage device 250 may be in a compressed, uncompiled and/or encrypted format. Furthermore, stored in data storage device 250 may be program elements that may be necessary for operation of server 200, such as an operating system and “device drivers” for allowing microprocessor 205 to interface with devices in communication with communication port 215. These program elements are known to those skilled in the art, and need not be described in detail herein.

FIG. 4 is a functional block diagram illustrating relationships between JSP page 254, Javabean 256, JDBC driver 258 and showme database 260. The arrowed lines between the illustrated elements depict data flow. As described above, the elements are used to create Web pages and to provide functionality according to embodiments of the present invention.

JSP page 254 includes JAVA code designed to process user requests received from Web server 252, to transmit responses, such as Web pages, to Web server 252 in response to user requests, and to interact with Javabean 256 In one example, JSP page 254 is a single page template which uses information from showme database 260 to create different Web pages according to embodiments of the invention. In a specific example referring to the elements of FIG. 1, JSP page 254 may be used to define appearances of modality tabs 110, search term input box 106, search results 108, instruction topic 110, instructional text 114, instructional text 116, and alternative media indicators 118 using data stored in showme database 260 which is retrieved by submitting a Structured Query Language (SQL) database inquiry to Javabean 256.

In order to facilitate such retrieval, Javabean 256 contains JAVA code to handle database interactions, to store search results, and to update JSP page 254 with retrieved data. Javabean 256 interacts with JDBC driver 258 in order to communicate with showme database 260. Specifically, Javabean 256 initializes JDBC driver 258 in order to open a connection to database 260 and an SQL query is executed, with the results of the inquiry being returned to Javabean 256. After execution and completion of a query, the connection is closed. According to some embodiments, connection pooling is used to ensure availability of a connection to showme database 260.

A tabular representation of a portion of showme database 260 is shown in FIGS. 5A and 5B. Showme database 260 of FIGS. 5A and 5B includes data used to present an instructional interface to a user according to embodiments of the invention. The data stored in showme database 260 may be received from any number of sources, such as from an external device over communication port 215 and from an operator using input device 220. Of course, the data may also be retrieved from removable media having the data stored thereon.

As will be understood by those skilled in the art, the representation and accompanying description of showme database 260 merely represent relationships between stored information. A number of other arrangements may be employed besides those suggested by the representation Similarly, the illustrated entries represent sample information only; those skilled in the art will understand that the number and content of the entries can be different from those illustrated.

Showme database 260 of FIGS. 5A and 5B includes several records, each of which includes several fields. Of course, showme database 260 is contemplated to have records and fields in addition to those shown The fields of each record specify: showme number 400; showme segment 402; modality 404, instruction topic 406; search terms 408, showme type 410; objectives 412; quick steps 414; clip A format 416; clip B format 418; clip C format 420; showme date 422; hits 424; status 426; revision 428; equipment 430; and rating 432.

Showme number 400 specifies a reference number associated with a particular showme. Showme segment 402 specifies whether the associated showme relates to clinical, professional, technical or other subject matter, while modality 404 identifies one or more of modality tabs 110 with which the showme is associated. For example, selection of a particular modality tab 110 may allow a user to search only those showme's associated in database 260 with the modality 404 corresponding to the selected modality tab.

Topic 406 reflects instructional topic 112 presented by instructional interface 104 during presentation of the associated showme. Search terms 408 identify those search terms which, if input by a user into search term input box 106, cause the associated topic 406 to be presented as a search result 108. Showme's may be identified as relating to a basic concept, an advanced concept, equipment repair or the like according to associated showme type 410.

As described with respect to topic 406, objectives 412 and quick steps 414 reflect instructional text 114 and instructional text 116, respectively, which are presented by instructional interface 104 during presentation of an associated showme. Similarly, clip A format 416, clip B format 418 and clip C format 420 reflect alternative media indicators 118 presented during presentation of the showme. More specifically, formats 416 to 420 identify particular alternative media presentations associated with the showme as well as the format of the presentations and the quick steps 414 with which each alternative media presentation is associated. The format may determine a type of alternative media indicator used to represent a presentation in instructional interface 104 while the identity of the presentations may be used to retrieve appropriate presentations from alternative media presentation database 262.

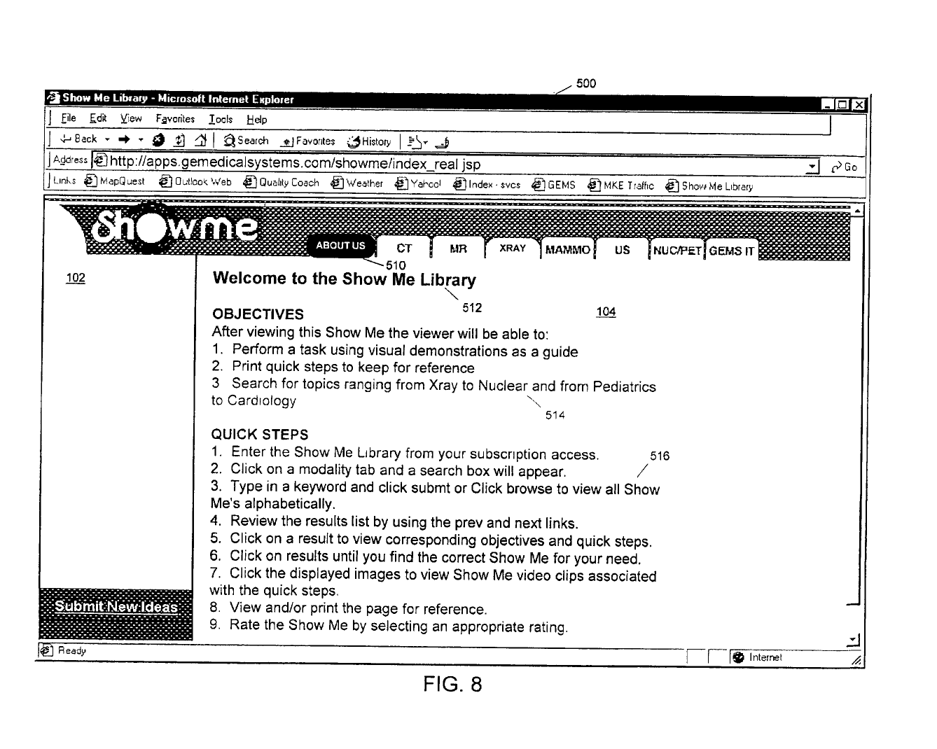

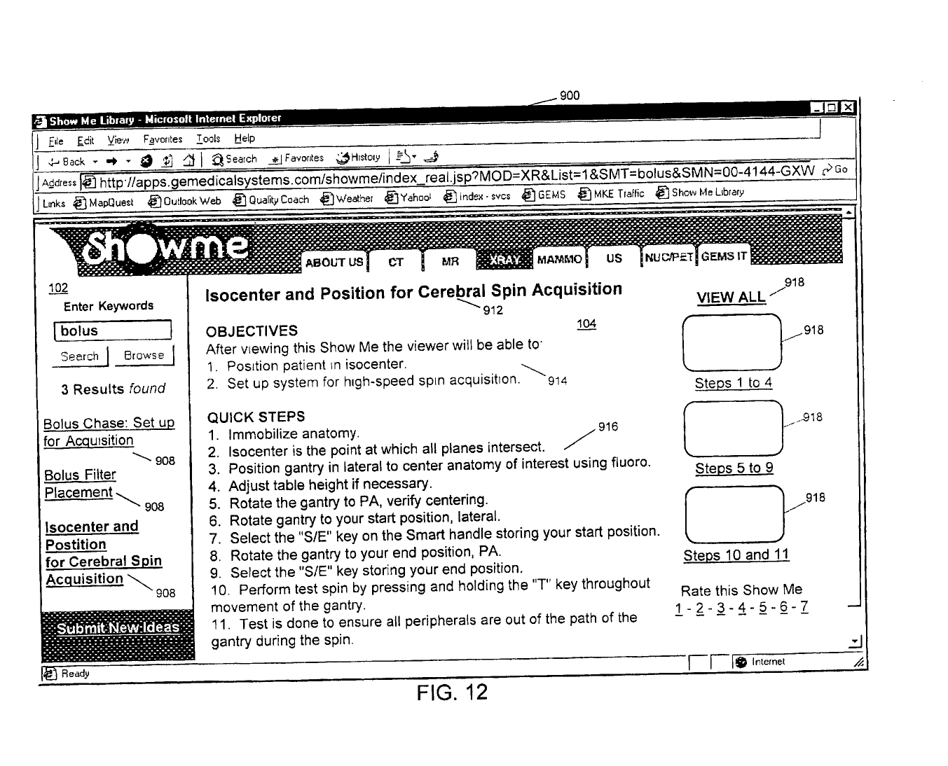

Showme date 422 specifies a date on which an associated showme was last revised, hits 424 specifies a number of times that the showme has been presented, status 426 indicates whether the showme is ready for presentation or in development, revision 428 specifies a software revision to which the showme applies, equipment 430 specifies particular equipment with which the showme deals, and rating 432 specifies an arithmetic mean of all ratings received to date regarding the associated showme. An example of a process which utilizes data stored in showme database 260 will be set forth with respect to FIGS. 8 to 13.

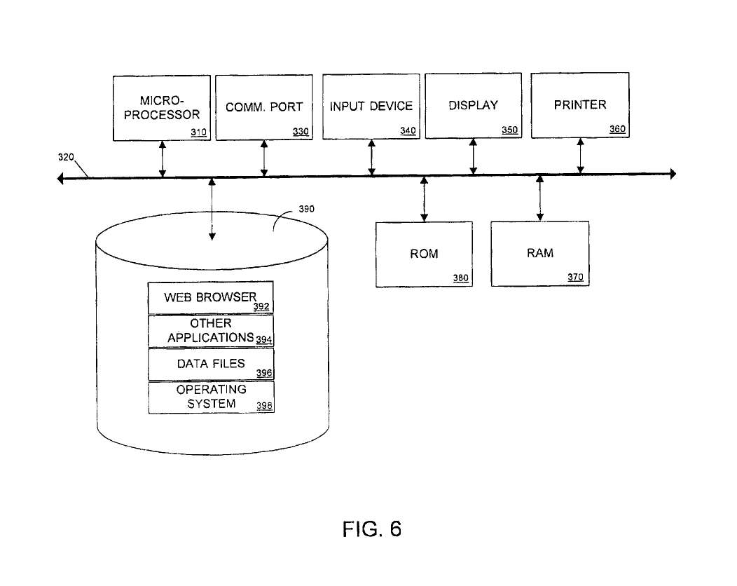

FIG. 6 is a block diagram illustrating an internal architecture of one type of user device 300. As shown, user device 300 according to the depicted embodiment includes microprocessor 310, communication port 330, input device 340, display 350, printer 360, RAM 370 and ROM 380, each of which is in communication with communication bus 320. Possible embodiments for each of these components are similar to those described with respect to identically-named components of FIG. 3, although functions performed by the components of FIG. 6 according to the invention may differ from those performed by the components of FIG. 3.

Specifically, input device 340 may be used to input search terms into search term input box 106, to select search results 108, to select alternative media indicators 118, and to manipulate rating Interface 120. Display 350 and printer 360 may be used to present instructional information, associated alternative media indicators, and associated alternative media presentations to a user according to the invention.

User storage device 390 is also in communication with communication bus 310 and stores processor-executable process steps of Web browser 392. The process steps may be executed by microprocessor 310 to provide a user with the ability to transmit information and to receive information such as Web pages over the Web. User storage device 390 also includes processor-executable process steps of other applications 394, data files 396 used in applications executed by microprocessor 310, and processor-executable process steps of operating system 398 upon which applications are executed.

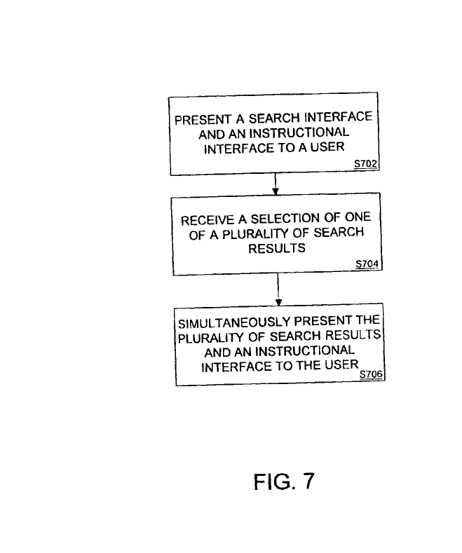

FIG. 7 is a flow diagram of processor-executable process steps executable by microprocessor 205 to provide instructional information according to one embodiment of the present invention. The process steps may be embodied in one or more of Web server 252, JSP page 254, Javabean 256, JDBC driver 258, and any other program code executed by microprocessor 205 of server 200. In other embodiments, the process steps are stored, in whole or in part, in an entity other than server 200 and executed, in whole or in part, by that or another entity. For example, the process steps may be embodied in an application stored in user storage device 390 and executed by microprocessor 310 of user device 300.

FIGS. 8 to 13 will be used to provide a specific example of the process of FIG. 7. In this regard, user interface 500 of FIG. 8 is presented to a user by display 350 of user device 300 after the user accesses a home page of a website hosted by Web server 252. More specifically, user interface 500 comprises a Web page transmitted to user device 300 in response to user input of an associated Web address into a user interface of Web browser 392. User interface 500 includes search interface 102 and instructional interface 104 as described above with respect to FIG. 1. No data is shown in search interface 102, while instructional interface 104 illustrates modality tabs 510, instruction topic 512, instructional text 514, and instructional text 516 of a default showme stored in showme database 260. Accordingly, these elements correspond respectively to modality 404, topic 406, objectives 412 and quick steps 414 associated with the default showme. It should be noted that user interface 500 does not include alternative media indicators because fields 416 to 420 associated with the default showme are not populated.

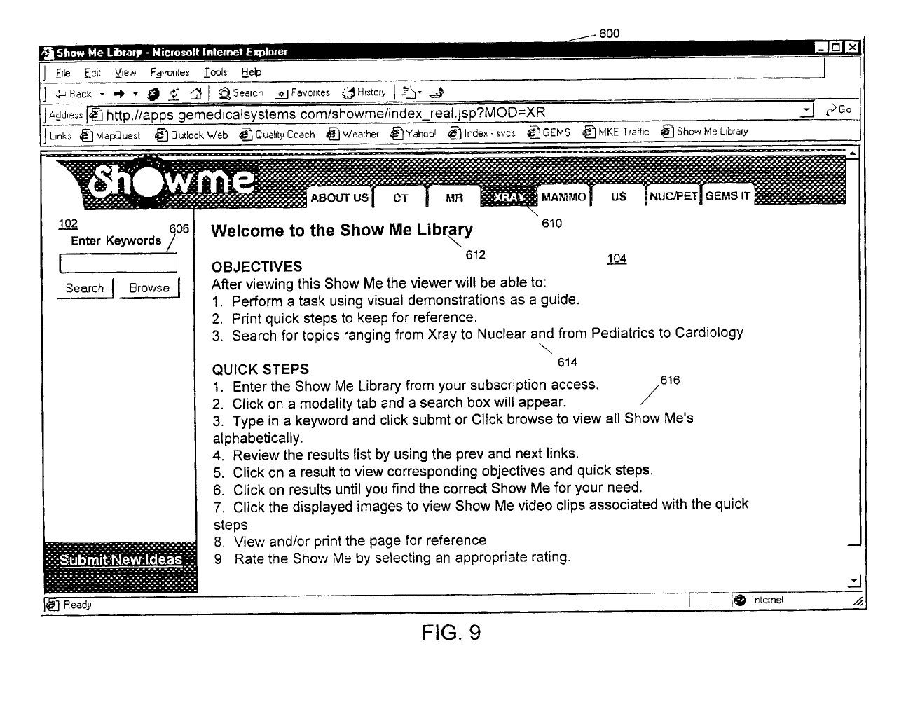

FIG. 9 is a view of user interface 600 presented in response to user selection of modality tab 610. As shown, instructional interface 104 of user interface 600 includes instruction topic 612, instructional text 614, and instructional text 616 of the default showme reflected in user interface 500. In addition, search interface 102 of user interface 600 includes search term input box 606 for inputting search terms.

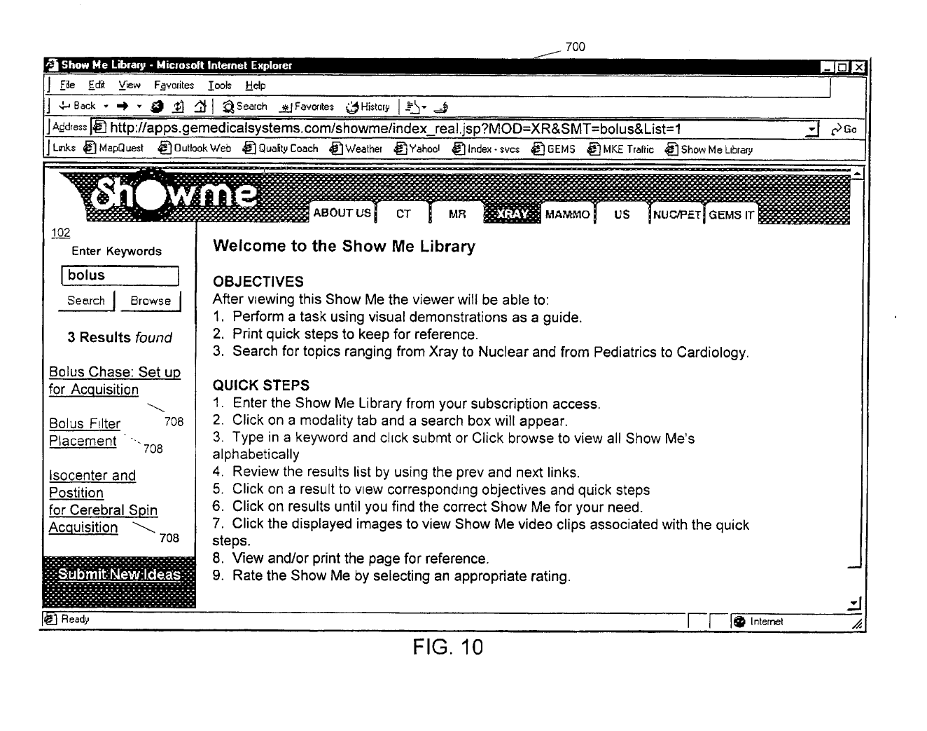

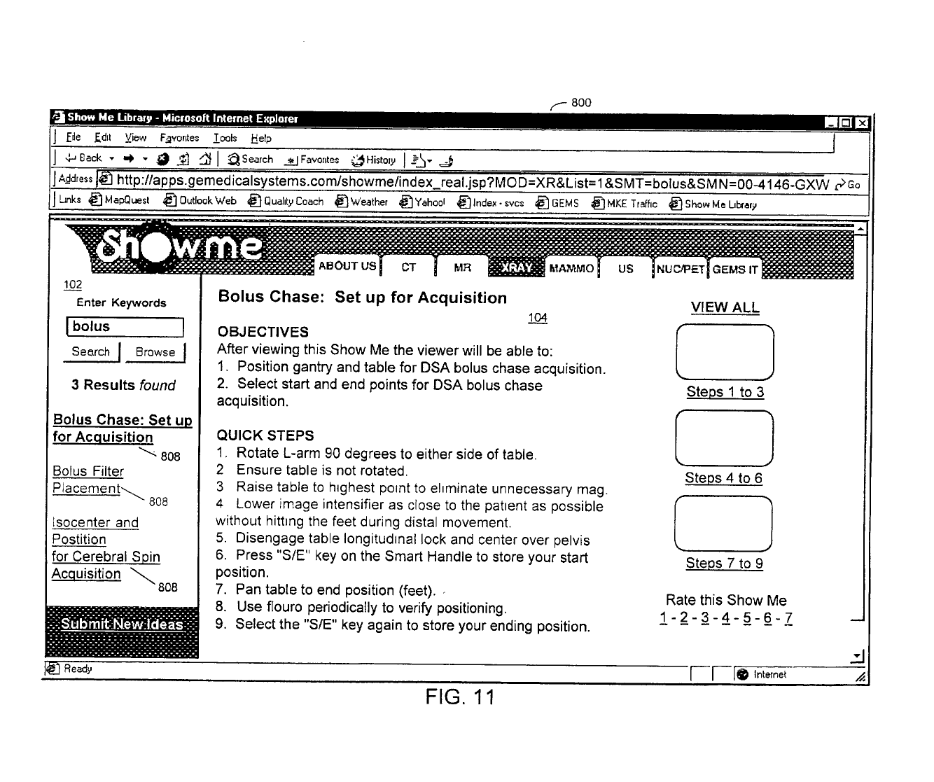

User interface 700 of FIG. 10 reflects user input of the search term “bolus” into search term input box 606 of user interface 600. More specifically, user interface 700 reflects input of the search term into search term input box 606, transmission of the search term to server 200, execution of an SQL query of showme database 260 to identify all showme's with which the search term is associated according to search terms field 408 and fields 406, 412 and 414, creation of a Web page having an instructional interface 104 identical to instructional interface 104 of user interface 600 and a search interface including the search results, and transmission of the Web page to user device 300. According to the present example, one of search results 708 is selected by the user, resulting in creation, transmission, and presentation of user interface 800 of FIG. 11.

Returning to FIG. 7, user interface 800 of FIG. 11 is intended to reflect one embodiment of step S702 According to step S702, user interface 800 presents search interface 102 for inputting search terms, for presenting a plurality of search results 808 and for allowing selection of one of the plurality of search results 808. It should be understood that search term 808 shown in bold was selected from user interface 700 and therefore is associated with the showme presented by instructional interface 104 of user interface 800. Also according to step S702, the showme presented by instructional interface 104 includes instructional text 814, instructional text 816, and alternative media indicators 818. As described above, elements 814 to 818 reflect data associated with showme number 400 “4144” in showme database 260.

After step S702, a selection of one of the presented plurality of search results is received in step S704. In the present example, the selection is a selection of one of search results 808 and the selection is received by server 200. User interface 900 of FIG. 11 is presented to a user in response to the received selection. Selected search result 908 is identified by bold lettering in search interface 102 and represents showme number 440 “4146” of showme database 260. Accordingly, instruction topic 912, instructional text 914 and 916 and alternative media indicators 918 reflect, respectively, data fields 406 and 412 through 420 associated with showme number 440 “4146”.

In accordance with step S706, user interface 900 simultaneously presents the plurality of search results presented in step S702 and an instructional interface corresponding to the search result selection received in step S704. As mentioned above, the features of the FIG. 7 process steps provide easier identification of relevant search results than do conventional instructional systems.

Although presentation of a search interface and an instructional interface to a user in steps S702 and S706 has been described as an action performed by user device 300, transmissions of information which represent such a search interface and an instructional interface are also to be considered presentations according to the invention. Transmission by server 200 of a Web page including these interfaces is one example of such a transmission.

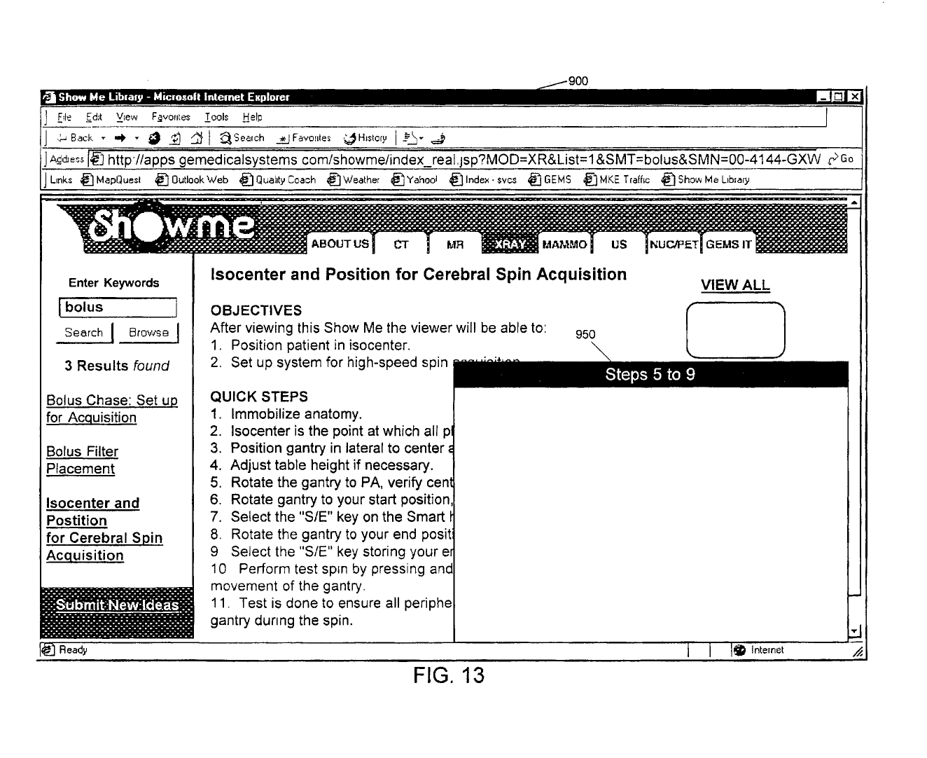

To complete the foregoing example, FIG. 13 illustrates user interface 900 after selection of one of alternative media indicators 918. The selected alternative media indicator 918 corresponds to field clip B format 418 of showme number 440 “4146”. Therefore, in response to the selection, alternative media presentation “FLASH7” is retrieved from alternative media presentation database 262, transmitted to user device 300, and presented to the user. As shown, window 950 is used to present the alternative media presentation.

Although the present invention has been described with respect to particular embodiments thereof, those skilled in the art will note that various substitutions may be made to those embodiments described herein without departing from the spirit and scope of the present invention.

What is claimed is:

1. A user interface for providing instructional information, comprising:
instructional text describing a plurality of steps to perform a task; and
a plurality of alternative media indicators, each of the plurality of alternative media indicators associated with one or more of the plurality of steps and selectable to cause presentation of an alternative media presentation instructing performance of the associated one or more of the plurality of steps.

2. A user interface according to claim 1, wherein a first of the alternative media indicators is associated with a first one or more of the plurality of steps, wherein a second of the alternative media indicators is associated with a second one or more of the plurality of steps, and wherein a third of the plurality of alternative media indicators is associated with the first one or more of the plurality of steps and with the second one or more of the plurality of steps.

3. A user interface according to claim 2, wherein each of the plurality of steps is associated exclusively with one of the alternative media indicators.

4. A user interface for providing instructional information, comprising:
a search interface for allowing input of search terms, for presenting a plurality of search results, and for allowing selection one of the plurality of search results; and
an instructional interface for presenting instructional text and an alternative media indicator associated with an alternative media presentation,
wherein, after selection of the one of the plurality of search results, the plurality of search results and the instructional interface are presented simultaneously, the simultaneously presented instructional interface comprising instructional text and an alternative media indicator corresponding to the selected one of the plurality of search results.

5. A user interface according to claim 4, wherein selection of another one of the plurality of search results causes the instructional interface to present instructional text and an alternative media indicator corresponding to the another one of the plurality of search results simultaneously with presentation of the plurality of search results.

6. A user interface according to claim 4, wherein the instructional text comprises a plurality of steps to perform a task.

7. A user interface according to claim 6, wherein the instructional interface presents a plurality of alternative media indicators.

8. A user interface according to claim 7, wherein each of the plurality of alternative media indicators is associated with one or more of the plurality of steps.

9. A user interface according to claim 8, wherein selection of one of the alternative media indicators causes presentation of an alternative media presentation, the alternative media presentation instructing performance of the associated one or more of the plurality of steps.

10. A user interface according to claim 9, wherein a first of the alternative media indicators is associated with a first one or more of the plurality of steps, wherein a second of the alternative media indicators is associated with a second one or more of the plurality of steps, and wherein a third of the plurality of alternative media indicators is associated with the first one or more of the plurality of steps and with the second one or more of the plurality of steps.

11. A user interface according to claim 9, wherein each of the plurality of steps is associated exclusively with one of the alternative media indicators.

12. An apparatus for providing instructional information, comprising:
an output device for presenting information;
an input device for receiving information;
a processor; and
a memory storing processor-executable process steps,
wherein the processor executes the processor-executable process steps: to present, using the output device, instructional text describing a plurality of steps to perform a task, and a plurality of alternative media indicators, each of the plurality of alternative media indicators associated with one or more of the plurality of steps; to receive, using the input device, a selection of one of the plurality of alternative media indicators; and to present, using the output device, an alternative media presentation instructing performance of the one or more of the plurality of steps associated with the selected alternative media indicator.

13. An apparatus according to claim 12, wherein a first of the alternative media indicators is associated with a first one or more of the plurality of steps, wherein a second of the alternative media indicators is associated with a second one or more of the plurality of steps, and wherein a third of the plurality of alternative media indicators is associated with the first one or more of the plurality of steps and with the second one or more of the plurality of steps.

14. An apparatus according to claim 13, wherein each of the plurality of steps is associated exclusively with one of the alternative media indicators.

15. An apparatus for providing instructional information, comprising:
an output device for presenting information;
an input device for receiving information;
a processor; and
a memory storing processor-executable process steps,
wherein the processor executes the processor-executable process steps: to present, using the output device, a search interface for inputting search terms, for presenting a plurality of search results, and for allowing selection of one of the plurality of search results, and an instructional interface for presenting instructional text and an alternative media indicator associated with an alternative media presentation; to receive, using the input device, a selection of the one of the plurality of search results; and, after the selection is received, to present, using the output device, the plurality of search results and the instructional interface simultaneously, the simultaneously presented instructional interface comprising instructional text and an alternative media indicator corresponding to the selected one of the plurality of search results.

16. An apparatus according to claim 15, wherein the processor further executes the process steps:
to receive a selection of another one of the plurality of search results; and
to present instructional text and an alternative media indicator corresponding to the another one of the plurality of search results in the instructional Interface.

17. An apparatus according to claim 15, wherein the instructional text comprises a plurality of steps to perform a task.

18 An apparatus according to claim 17, wherein the instructional interface presents a plurality of alternative media indicators.

19. An apparatus according to claim 18, wherein each of the plurality of alternative media indicators is associated with one or more of the plurality of steps.

20 An apparatus according to claim 19, wherein the processor further executes the process steps:
to receive a selection of one of the alternative media indicators; and
to present an alternative media presentation, the alternative media presentation instructing performance of the associated one or more of the plurality of steps.

21. An apparatus according to claim 20, wherein a first of the alternative media indicators is associated with a first one or more of the plurality of steps, wherein a second of the alternative media indicators is associated with a second one or more of the plurality of steps, and wherein a third of the plurality of alternative media indicators is associated with the first one or more of the plurality of steps and with the second one or more of the plurality of steps

22 An apparatus according to claim 20, wherein each of the plurality of steps is associated exclusively with one of the alternative media indicators

23. A method for providing instructional information, comprising:
presenting instructional text describing a plurality of steps to perform a task, and a plurality of alternative media indicators, each of the plurality of alternative media indicators associated with one or more of the plurality of steps;
receiving a selection of one of the plurality of alternative media indicators, and
presenting an alternative media presentation instructing performance of the one or more of the plurality of steps associated with the selected alternative media indicator.

24. A method according to claim 23, wherein a first of the alternative media indicators is associated with a first one or more of the plurality of steps, wherein a second of the alternative media indicators is associated with a second one or more of the plurality of steps, and wherein a third of the plurality of alternative media indicators is associated with the first one or more of the plurality of steps and with the second one or more of the plurality of steps

25. A method according to claim 24, wherein each of the plurality of steps is associated exclusively with one of the alternative media indicators.

26. A method for providing instructional information, comprising:
presenting a search interface for inputting search terms, for presenting a plurality of search results, and for allowing selection of one of the plurality of search results, and an instructional interface for presenting instructional text and an alternative media indicator associated with an alternative media presentation;
receiving a selection of the one of the plurality of search results, and
presenting, after the selection is received, the plurality of search results and the instructional interface simultaneously, the simultaneously presented instructional interface comprising instructional text and an alternative media indicator corresponding to the selected one of the plurality of search results.

27. A method according to claim 26, further comprising:
receiving a selection of another one of the plurality of search results; and
presenting instructional text and an alternative media indicator corresponding to the another one of the plurality of search results in the instructional interface.

28. A method according to claim 27, wherein the instructional text comprises a plurality of steps to perform a task.

29. A method according to claim 28, wherein the instructional interface presents a plurality of alternative media indicators.

30. A method according to claim 29, wherein each of the plurality of alternative media indicators is associated with one or more of the plurality of steps.

31. A method according to claim 30, further comprising:
receiving a selection of one of the alternative media indicators, and
presenting an alternative media presentation, the alternative media presentation instructing performance of the associated one or more of the plurality of steps.

32 A method according to claim 31, wherein a first of the alternative media indicators is associated with a first one or more of the plurality of steps, wherein a second of the alternative media indicators is associated with a second one or more of the plurality of steps, and wherein a third of the plurality of alternative media indicators is associated with the first one or more of the plurality of steps and with the second one or more of the plurality of steps.

33. A method according to claim 31, wherein each of the plurality of steps is associated exclusively with one of the alternative media indicators.

34. A computer-readable medium storing processor-executable process steps to provide instructional information, the process steps comprising:
a presenting step to present instructional text describing a plurality of steps to perform a task, and a plurality of alternative media indicators, each of the plurality of alternative media indicators associated with one or more of the plurality of steps;
a receiving step to receive a selection of one of the plurality of alternative media indicators; and
a presenting step to present an alternative media presentation instructing performance of the one or more of the plurality of steps associated with the selected alternative media indicator.

35. A computer-readable medium according to claim 34, wherein a first of the alternative media indicators is associated with a first one or more of the plurality of steps, wherein a second of the alternative media indicators is associated with a second one or more of the plurality of steps, and wherein a third of the plurality of alternative media indicators is associated with the first one or more of the plurality of steps and with the second one or more of the plurality of steps.

36. A computer-readable medium according to claim 35, wherein each of the plurality of steps is associated exclusively with one of the alternative media indicators.

37. A computer-readable medium storing processor-executable process steps to provide instructional information, the process steps comprising:
a presenting step to present a search interface for inputting search terms, for presenting a plurality of search results, and for allowing selection of one of the plurality of search results, and an instructional interface for presenting instructional text and an alternative media indicator associated with an alternative media presentation;
a receiving step to receive a selection of the one of the plurality of search results, and
a presenting step to present, after the selection is received, the plurality of search results and the instructional interface simultaneously, the simultaneously presented instructional interface comprising instructional text and an alternative media indicator corresponding to the selected one of the plurality of search results.

38. A computer-readable medium according to claim 37, the process steps further comprising:
a receiving step to receive a selection of another one of the plurality of search results; and
a presenting step to present instructional text and an alternative media indicator corresponding to the another one of the plurality of search results in the instructional interface.

39. A computer-readable medium according to claim 38, wherein the instructional text comprises a plurality of steps to perform a task.

40. A computer-readable medium according to claim 39, wherein the instructional interface presents a plurality of alternative media indicators.

41. A computer-readable medium according to claim 40, wherein each of the plurality of alternative media indicators is associated with one or more of the plurality of steps.

42. A computer-readable medium according to claim 41, the process steps further comprising:
a receiving step to receive a selection of one of the alternative media indicators, and
a presenting step to present an alternative media presentation, the alternative media presentation instructing performance of the associated one or more of the plurality of steps.

43 A computer-readable medium according to claim 42, wherein a first of the alternative media indicators is associated with a first one or more of the plurality of steps, wherein a second of the alternative media indicators is associated with a second one or more of the plurality of steps, and wherein a third of the plurality of alternative media indicators is associated with the first one or more of the plurality of steps and with the second one or more of the plurality of steps.

44. A computer-readable medium according to claim 42, wherein each of the plurality of steps is associated exclusively with one of the alternative media indicators.
